(19) United States
(12) Patent Application Publication
(10) Pub. No.: US 2014/0362398 A1
(43) Pub. Date: Dec. 11, 2014

(54) Mechanism for Tracking Print Job Segments

(71) Applicants: David Ward, Broomfield, CO (US); John Thomas Varga, Longmont, CO (US); Thomas Georges Cyrille Kooh, Westminster, CO (US)

(72) Inventors: David Ward, Broomfield, CO (US); John Thomas Varga, Longmont, CO (US); Thomas Georges Cyrille Kooh, Westminster, CO (US)

(73) Assignee: Ricoh Company, Ltd., Tokyo (JP)

(21) Appl. No.: 13/911,453

(22) Filed: Jun. 6, 2013

(51) Int. Cl. G06K 15/02

(52) U.S. Cl. CPC G06K 15/1809
USPC 358/1.15

(57) ABSTRACT

A method is disclosed. The method includes printing a first print job, suspending the first print job to print a second print job, determining if the print job is to be resumed upon completion of printing of the second print job, generating a segment separator page corresponding to the first print job if the first print job is to be resumed and resuming printing of the first print job.

### FIELD OF THE INVENTION

The invention relates to the field of printing systems, and in particular, to the management of print jobs produced at a printing system.

### BACKGROUND

Computing centers that employ one or more printers to serve a group of users, such as a networked group or other work group, typically rely on the printers to batch process print jobs (e.g., print-out a series of different print jobs in succession). Such printers produce separator pages which are used for identification and segregation of print jobs in an office, departmental or other shared or multi-user printing environment. Separator pages generated at the beginning of a print job are commonly referred to as headers, while pages generated after a print job are referred to as trailers. Such separator pages include one or two lines of text that identify the requesting party and identify the job number.

Current printers permit a print job to be suspended and resumed at a later time, or prioritized to the top of a queue, thus interrupting a current job (e.g., Print Now). When these operations occur, the stack of printed pages is interrupted with another job. Presently, the resumption of the interrupted job does not print a new separator page since printers only print separator pages at the start and/or end of an entire job.

If a job is continually interrupted and resumed, stacks of job output can occur which have no association with the other pieces of the job, and no separator pages are printed to enable the operator to identify the parts of jobs that follow or to properly stack the pieces of the job back together in the proper order.

Accordingly, a mechanism to generate a separator page each time a print job is resumed is desired.

### SUMMARY

In one embodiment, a method is disclosed. The method includes printing a first print job, suspending the first print job to print a second print job, determining if the print job is to be resumed upon completion of printing of the second print job, generating a segment separator page corresponding to the first print job if the first print job is to be resumed and resuming printing of the first print job.

### BRIEF DESCRIPTION OF THE DRAWINGS

A better understanding of the present invention can be obtained from the following detailed description in conjunction with the following drawings, in which:

FIG. 1 illustrates one embodiment of a printing system;

FIG. 2 is a flow diagram illustrating one embodiment of print job management; and

FIG. 3 illustrates one embodiment of a computer system.

### DETAILED DESCRIPTION

A mechanism for tracking print job segments is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

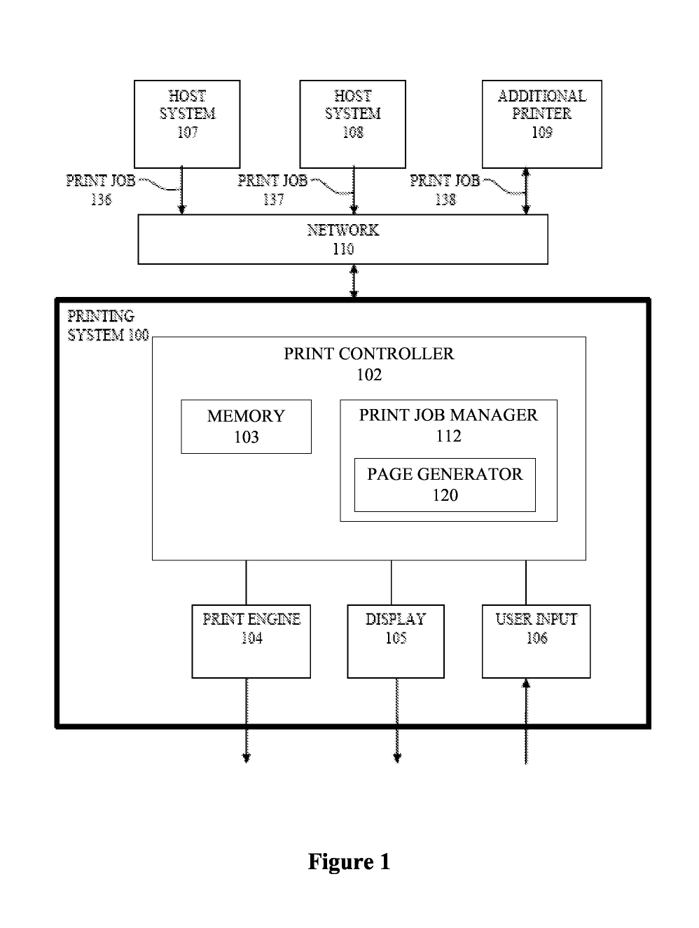

FIG. 1 is a block diagram illustrating one embodiment of a printing system 100. Printing system 100 is a system used to provide marks on a media, such as a continuous forms printer or a cut sheet page printer. Printing system 100 may include any digital hardcopy output device, such as printers, copiers, multifunction printers (MFP's) and facsimiles.

In one embodiment, printing system 100 is shared by multiple users. In such an embodiment, printing system 100 includes a print controller 102 and one or more print engines 104. Print controller 102 includes any system, server, or components operable to interface one or more host systems 107 and 108, and a printer 109, via network 110 with one or more print engines 104, and to control the printing of print jobs 136-138 received from the host systems 107 and 108, and a printer 109, respectively, on print engine 104. Print engine 104 provides an imaging process to mark a printable medium, such as paper.

According to one embodiment, print controller 102 includes memory 103 and a print job manager 112. Memory 103 includes any storage system operable to store data. In one embodiment, print job manager 112 manages the printing of documents at printing system 100. Particularly, print job manager 112 controls print jobs as they wait to print, arranges the priority of the print jobs, generates separator pages and distributes jobs to the destination print engine 104. In one embodiment, print job manager 112 may be implemented using either InfoPrint Manager (IPM) or InfoPrint ProcessDirector (IPPD), although other types of print job managers may be used instead.

In one embodiment, print job manager 112 holds received print jobs in memory 103 before processing the print job. In such an embodiment, memory 103 stores the print jobs as either a data file or rasterized file. For example, print jobs stored as rasterized files reduce print time for the held jobs versus those stored as data files. Once stored, each print job may be held until the user that generated the print job retrieves the corresponding document from printing system 100, at which time the print job is processed and printed.

In a further embodiment, a user may release a selected job for printing at printing system 100 via user input 106. Printing system 100 thereby processes the print job by printing via print engine 104. In still a further embodiment, multiple selected print jobs being held for a particular user may be simultaneously processed and printed at print engine 104. Therefore, all print jobs for the same user are printed together when multiple print jobs are released to print.

According to one embodiment, print job manager 112 includes a separator page generator 120 that is implemented to control the generation of print job separator pages for jobs stored in memory 103. In a further embodiment, print job manager 112 instructs separator page generator 120 to produce a separator page at the beginning and/or the end of a print job. In yet a further embodiment, print job manager 112 instructs separator page generator 120 to generate a separator page each time a job is resumed after printing pages from another job. In such an embodiment, each new separator page is consecutively numbered to enable an operator to reassemble the output in a proper order.

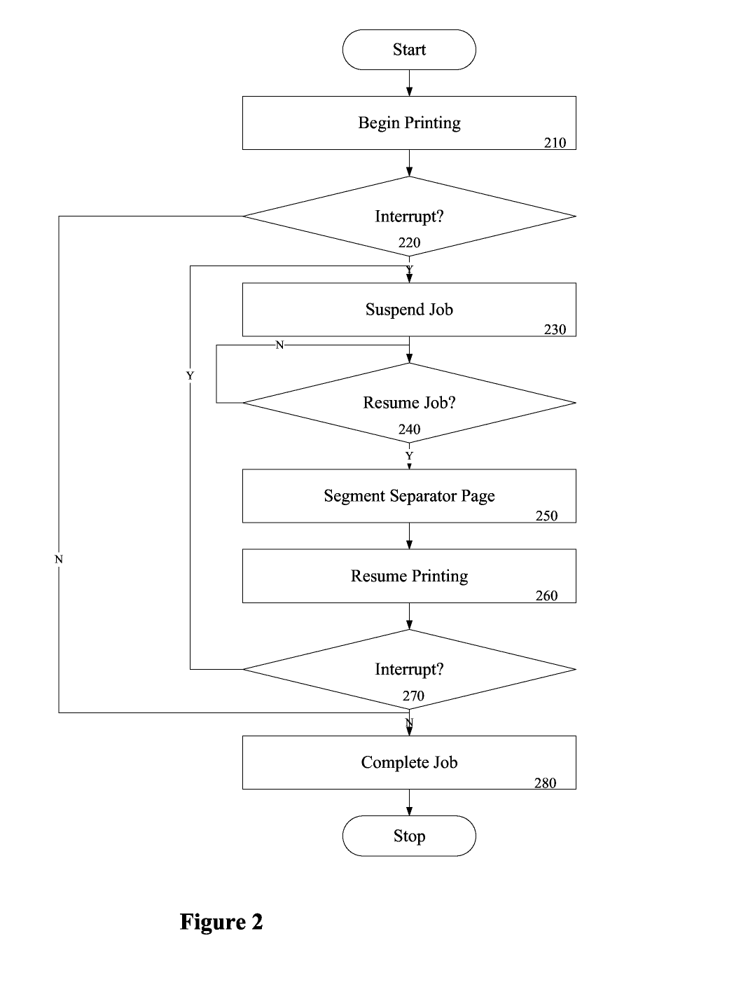

FIG. 2 is a flow diagram illustrating one embodiment of generating segment separator pages at printing system 100. At processing block 210, a job begins to be printed. In one embodiment, a beginning separator page is generated if indicated in separator page settings loaded at page generator 120. At decision block 220, a determination is made as to whether the current print job is to be interrupted. As discussed above, the job may be interrupted by another job via a Print Now operation. If the current print job is to be interrupted, it is suspended, processing block 230. According to one embodiment, a section count is incremented along with the job's resume information whenever a job is suspended. Thus, such information is maintained at print job manager 112 for each active job.

At decision block 240, it is determined whether the job is ready to resume. If so, a segment separator page is printed at processing block 250. In one embodiment, the segment separator page includes the segment separator page includes a job number corresponding to the interrupted print job and a section count corresponding to the segment number being printed. In a further embodiment, the job number is the same for all sections, even when the internal number is changed.

In a further embodiment, an indication is displayed on a display device 105 (e.g., an Op Panel) with the same information to enable the operator to clear out stackers and add the new section to previously stacked sections to save paper. Printing is therefore paused until the stacker is emptied, and the information is preserved on the panel. For each job resumed in a non-print mode, the operator is prompted to tend to the stacker so the information of the next job section is not lost.

At processing block 260, printing of the job is resumed. At decision block 270, a determination is again made as to whether the current print job is to be interrupted. If at decision block 220 or 270 there is a determination that the job is not to be interrupted, printing of the job is completed, processing block 280. An ending separator page is generated if indicated in separator page settings loaded at page generator 120. If selected to be printed, an ending separator page includes to final section count including the total number of job segments to provide an indication as to when the job is completed and a number of printed sections. In one embodiment, an ending separator page may be configured to print only if the following job has no beginning separator page.

If at decision block 270, there is a determination that the job is to be interrupted, control is returned to processing block 230 where the job is again suspended. According to one embodiment, the Print Now also performs a suspend, and thus may also print an intermediate separator page or display an Op Panel message. Since these jobs are tagged by the submitter, they may override the Op Panel warning in a “Lights Out” printing mode by always forcing the intermediate separator.

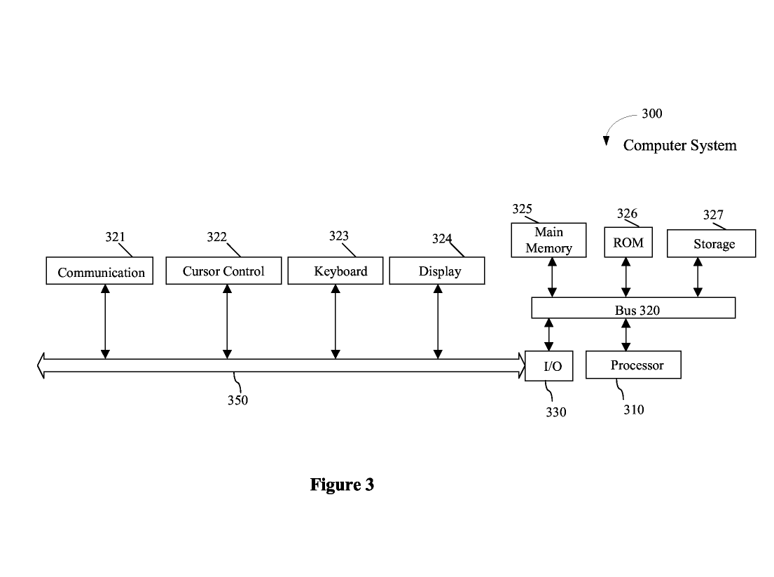

FIG. 3 illustrates a computer system 300 on which printing system 100 may be implemented. Computer system 300 includes a system bus 320 for communicating information, and a processor 310 coupled to bus 320 for processing information.

Computer system 300 further comprises a random access memory (RAM) or other dynamic storage device 325 (referred to herein as main memory), coupled to bus 320 for storing information and instructions to be executed by processor 310. Main memory 325 also may be used for storing temporary variables or other intermediate information during execution of instructions by processor 310. Computer system 300 also may include a read only memory (ROM) and or other static storage device 326 coupled to bus 320 for storing static information and instructions used by processor 310.

A data storage device 325 such as a magnetic disk or optical disc and its corresponding drive may also be coupled to computer system 300 for storing information and instructions. Computer system 300 can also be coupled to a second I/O bus 350 via an I/O interface 330. A plurality of I/O devices may be coupled to I/O bus 350, including a display device 324, an input device (e.g., an alphanumeric input device 323 and or a cursor control device 322). The communication device 321 is for accessing other computers (servers or clients). The communication device 321 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. An article of manufacture comprising a machine-readable medium including data that, when accessed by a machine, cause the machine to perform operations comprising:
printing a first print job;
suspending the first print job to print a second print job;
determining if the print job is to be resumed upon completion of printing of the second print job;
generating a segment separator page corresponding to the first print job if the first print job is to be resumed; and
resuming printing of the first print job.

2. The article of manufacture of claim 1 comprising a machine-readable medium including data that, when accessed by a machine, further cause the machine to perform operations comprising incrementing a section count upon suspending the first print job.

3. The article of manufacture of claim 1 comprising a machine-readable medium including data that, when accessed by a machine, further cause the machine to perform operations comprising:
suspending the first print job to print a third print job after resuming printing of the first print job; and
determining if the print job is to be resumed upon completion of printing of the third print job;
generating a second segment separator page corresponding to the first print job if the first print job is to be resumed; and
resuming printing of the first print job.

4. The article of manufacture of claim 3 wherein the first and second segment separator pages include a job number corresponding to the first print job.

5. The article of manufacture of claim 4 wherein the first segment separator page includes a first section count and the second segment separator page includes a second section count.

6. The article of manufacture of claim 1 comprising a machine-readable medium including data that, when accessed by a machine, further cause the machine to perform operations comprising generating a beginning separator page prior to printing the first print job.

7. The article of manufacture of claim 4 comprising a machine-readable medium including data that, when accessed by a machine, further cause the machine to perform operations comprising generating an ending separator page after the first print job has completed printing.

8. The article of manufacture of claim 7 wherein the ending separator page includes a final section count to provide an indication as to a total number of printed sections.

9. The article of manufacture of claim 8 wherein the ending separator page may be configured to print only if a subsequent print job does not have a beginning separator page.

10. The article of manufacture of claim 1 wherein the first print job is interrupted by the second job via a Print Now operation.

11. A printing system comprising:
a storage device;
a print job manager to store received print jobs in the storage device and to suspend printing of a first print job to print a second print job, and
a page generator to generate a segment separator page corresponding to the first print job prior to resuming printing of the first print job.

12. The printing system of claim 11 wherein the print job manager increments a section count upon suspending the first print job.

13. The printing system of claim 11 wherein the print job manager suspends the first print job to print a third print job after resuming printing of the first print job, determines if the print job is to be resumed upon completion of printing of the third print job, and the page generator generates a second segment separator page corresponding to the first print job if the first print job is to be resumed.

14. The printing system of claim 13 wherein the first and second segment separator pages include a job number corresponding to the first print job.

15. The printing system of claim 14 wherein the first segment separator page includes a first section count and the second segment separator page includes a second section count.

16. The printing system of claim 11 wherein the page generator generates a beginning separator page prior to the printing of the first print job.

17. The printing system of claim 14 wherein the page generator generates an ending separator page after the first print job has completed printing.

18. The printing system of claim 17 wherein the ending separator page includes a final section count to provide an indication as to a total number of printed sections.

19. The printing system of claim 18 wherein the ending separator page may be configured to print only if a subsequent print job does not have a beginning separator page.

20. The printing system of claim 11 wherein the first print job is interrupted by the second job via a Print Now operation.
